(19) United States
(12) Patent Application Publication
(10) Pub. No.: US 2025/0104035 A1
(43) Pub. Date: Mar. 27, 2025

(54) STORE SERVER, SALES INFORMATION MANAGEMENT SYSTEM, AND METHOD

(71) Applicant: Toshiba Tec Kabushiki Kaisha, Tokyo (JP)

(72) Inventor: Ayato WATANABE, Izunokuni Shizuoka (JP)

(21) Appl. No.: 18/805,422

(22) Filed: Aug. 14, 2024

(30) Foreign Application Priority Data
Sep. 26, 2023 (JP) 2023-163102

(51) Int. Cl. G06Q 20/20

(52) U.S. Cl. CPC G06Q 20/202

(57) ABSTRACT

A store server for managing a plurality of devices in a store via a store network, includes a network interface connectable to the store network, a memory that stores: a priority value assigned to each of the devices, and indicators for each device indicating frequency of use in time periods of a day, and a processor configured to: determine a priority order for the devices based on the priority values and the indicators for the devices stored in the memory, and control communication with each of the devices via the network interface according to the determined priority order.

### CROSS-REFERENCE TO RELATED APPLICATION(S)

This application is based upon and claims the benefit of priority from Japanese Patent Application No. 2023-163102, filed Sep. 26, 2023, the entire contents of which are incorporated herein by reference.

### FIELD

Embodiments described herein relate generally to a store server, a sales information management system, and a method.

### BACKGROUND

Conventionally, a cloud server is installed in the headquarters of a grocery store chain for managing data related to its chain stores, and an information processing apparatus such as a store server (hereinafter, also referred to as an edge server) is installed in each store and connected to the cloud server. The edge server is connected to a plurality of edge devices including a network camera and a digital signage terminal, in addition to point-of-sale (POS) terminals that play a major role in the store, and controls and manages such edge devices.

The edge server is connected to the POS terminals and the edge devices via a network provided in the store. Therefore, if the network is congested, a communication delay may occur between the edge server and the edge devices, and a delay or an error may occur in transmission and reception of data to and from the POS terminals.

### SUMMARY OF THE INVENTION

Embodiments of the present disclosure provide a store server, a sales information management system, and a method for reducing occurrence of a communication delay between the store server and a plurality of devices.

A store server for managing a plurality of devices in a store via a store network, comprises a network interface connectable to the store network, a memory that stores: a priority value assigned to each of the devices, and a plurality of indicators for each of the devices indicating frequency of use of each of the devices in a plurality of time periods of a day, and a processor configured to: determine a priority order for the devices based on the priority values assigned to the devices and the indicators for the devices stored in the memory, and control communication with each of the devices via the network interface according to the determined priority order.

### BRIEF DESCRIPTION OF THE DRAWINGS

FIG. 1 is a schematic diagram illustrating of an information processing system according to an embodiment.

FIG. 2 is a block diagram illustrating a hardware configuration of a cloud server according to an embodiment.

FIG. 3 is a block diagram illustrating a hardware configuration of an edge server according to an embodiment.

FIG. 4 is a diagram illustrating a hardware configuration of a POS terminal according to an embodiment.

FIG. 5 is a diagram illustrating a functional configuration of the POS terminal.

FIG. 6 is a block diagram illustrating a functional configuration of the edge server.

FIG. 7 depicts a data structure of priority information according to an embodiment.

FIG. 8 depicts a data structure of usage information according to an embodiment.

FIG. 9 depicts a data structure of priority order information according to an embodiment.

FIG. 10 is a flowchart illustrating a control process executed by an edge server according to an embodiment.

### DETAILED DESCRIPTION

Hereinafter, embodiments of an information processing apparatus or a store server and an information processing system or a sales information management system will be described with reference to the accompanying drawings. In the embodiments described below, an edge server is described as an example of the information processing apparatus or the store server. Note that embodiments of this disclosure are not limited to the configurations, functions, and the like of the examples described below.

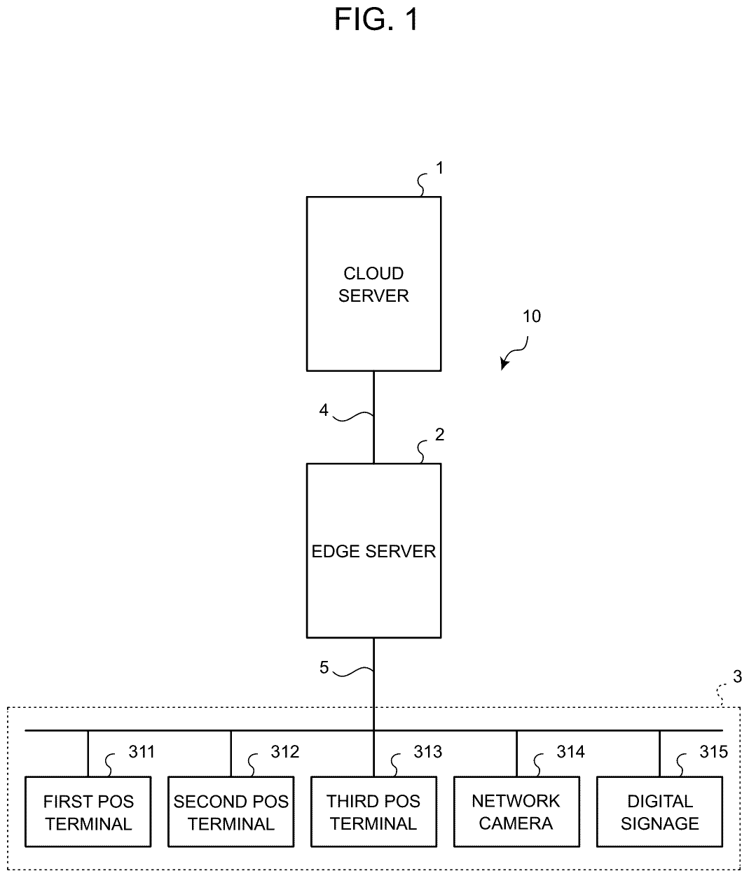

FIG. 1 is a schematic diagram illustrating an example of an information processing system 10 or a sales information management system according to an embodiment. The information processing system 10 includes a cloud server 1, an edge server 2, and a plurality of edge devices 3.

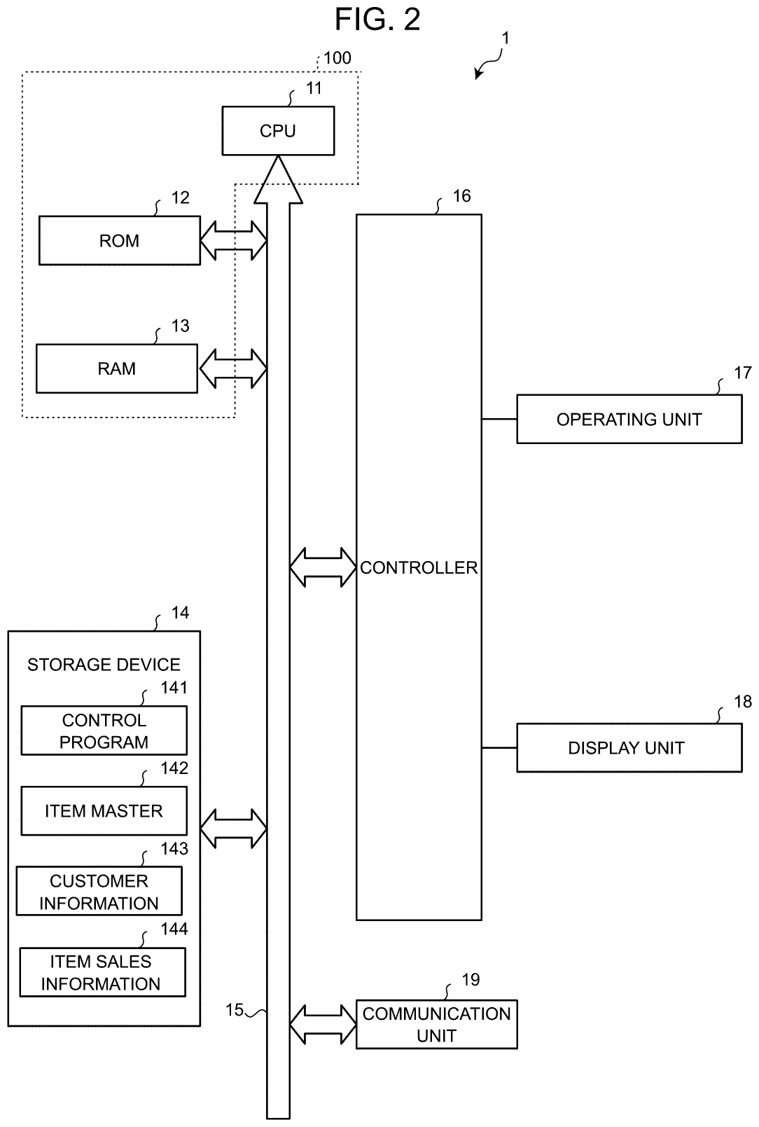

The cloud server 1 is, for example, a server installed in a headquarters of a company, which operates a plurality of stores such as grocery stores. The cloud server 1 includes one or a plurality of computers. The cloud server 1 transmits an item master 142 (see FIG. 2) to the edge server 2 installed in each store. The item master 142 is a database in which code information such as an item code uniquely assigned to each item and item information such as a name, a price, and an item classification of the item are associated with each other. Further, the cloud server 1 receives and manages customer information 143 (see FIG. 2) from the edge server 2 of each store. The customer information 143 includes various pieces of information related to a customer name, a customer identification (ID) for identifying a customer, and the like.

Further, the cloud server 1 receives and manages item sales information 144 (see FIG. 2) from the edge server 2 of each store. The item sales information 144 is information generated by POS terminals performing a registration process and a payment process of purchased items, and indicates information related to the registration process and the payment process of the items. That is, the cloud server 1 is a server capable of receiving, via a communication line 4, the edge server 2 and item sales information indicating information related to the item registration process and the payment process.

The cloud server 1 transmits a copy of the item master 142 to the edge server 2 of each store, so that the items can be sold at the same price at each store. Further, the cloud server 1 manages the customer information 143 and the item sales information 144 so as to analyze the trend of customers who purchases items at each store or the sales trend of the item. Further, the cloud server 1 is connected to the edge server 2 of each store via the communication line 4 that is, for example, a dedicated line or an Internet line.

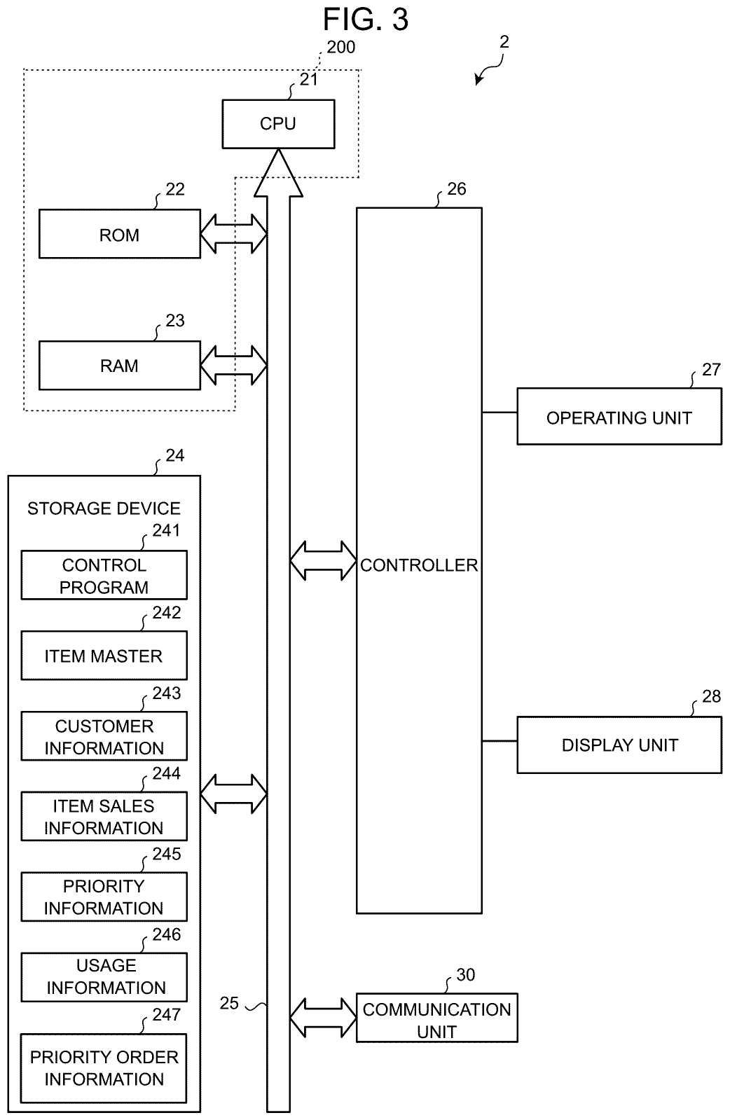

The edge server 2 is a server device such as a store server installed in each store. The edge server 2 controls and manages the edge devices 3 provided in the store. For example, the edge server 2 performs an information process related to a store on the basis of information transmitted from the edge device 3. For example, the edge server 2 collects item sales information (see FIG. 3) including item information of items settled by the POS terminals in the store, and manages the sales of the store. Further, the edge server 2 is connected to the cloud server 1 via the communication line 4 that is, for example, a dedicated line or an Internet line. Further, the edge server 2 is connected to the edge devices 3 of the store via a communication line 5 such as a Local Area Network (LAN).

The edge devices 3 are provided in each store and are communicably connected to the edge server 2 via the communication line 5. The edge devices 3 include, for example, a first POS terminal 311, a second POS terminal 312, a third POS terminal 313, a network camera 314, and a digital signage terminal 315. Hereinafter, among the edge devices 3, the first POS terminal 311, the second POS terminal 312, and the third POS terminal 313 are collectively referred to as the POS terminal.

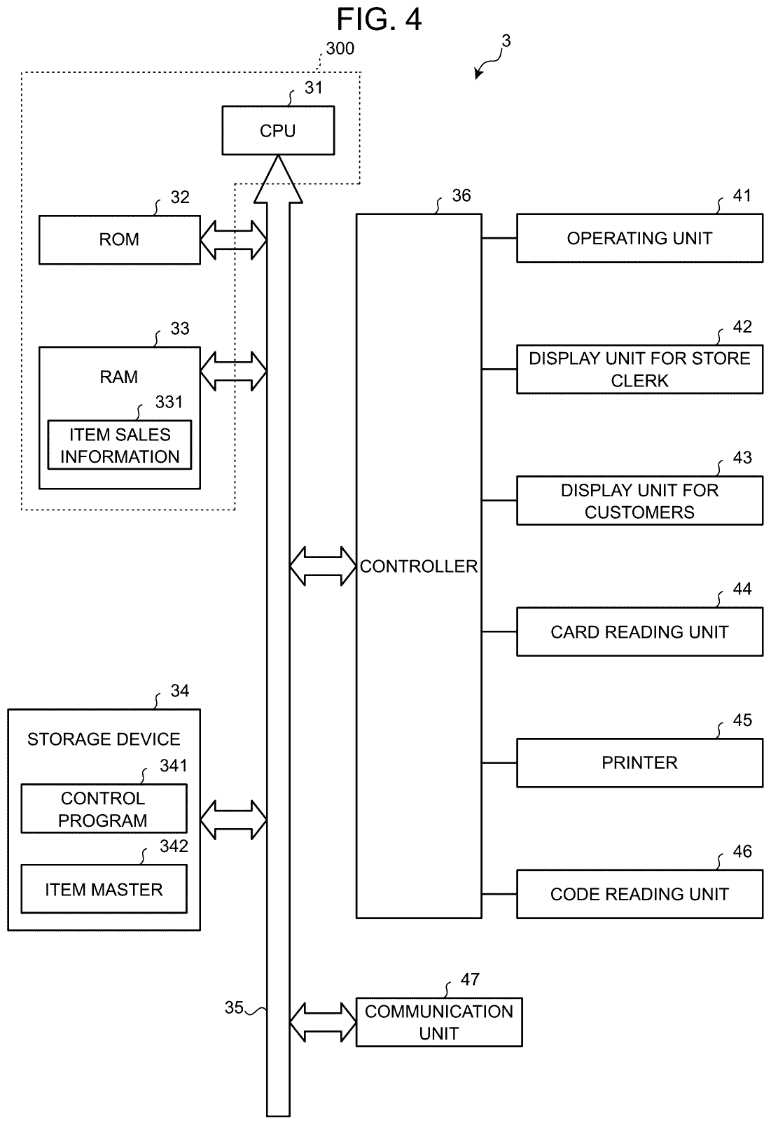

The POS terminal executes an item registration process and a payment process on an item sold at a store. The item registration process includes a process of reading a symbol attached to an item, retrieving and displaying item information such as an item name and a price of the item based on an item code for specifying the item associated with the symbol, and storing the item information in the storage device 34 (see FIG. 4).

In addition, the payment process refers to a process of displaying a total amount and a change amount (hereinafter referred to as “item sales information”) related to a transaction with a customer based on the item information of the item subjected to the item registration process. The payment process includes a process of issuing a receipt on which the item information and the item sales information of the settled item are printed. The POS terminal acquires a copy of the item master 342 (see FIG. 4) used for specifying the item from the edge device 3, or transmits the item sales information of the item for which the payment process has been completed to the edge device 3.

The network camera 314 is, for example, a camera that acquires imaging data obtained by imaging a predetermined area in the store. The predetermined area in the store is, for example, an area including a movement of a person moving in the store, an item displayed in the store, and the like. The network camera 314 outputs the acquired image data to the edge server 2.

As another example, the network camera 314 is a reading device that reads a code symbol, a discount label, or the like attached to an item, and acquires imaging data obtained by imaging the item. The digital signage terminal 315 is a terminal device that displays signage information related to information such as advertisement information and event information. The digital signage terminal 315 acquires signage information from the edge server 2 and displays the signage information based on an instruction transmitted from the edge server 2. Note that the information displayed by the digital signage terminal 315 is not limited to this, and information indicating a cooking method using an item may be displayed.

Next, a hardware configuration of the cloud server 1 will be described with reference to FIG. 2. FIG. 2 is a block diagram illustrating an example of a hardware configuration of the cloud server 1. In FIG. 2, although the cloud server 1 is described as a single computer, it may be configured by a plurality of computers.

As illustrated in FIG. 2, the cloud server 1 includes a central processing unit (CPU) 11, a read only memory (ROM) 12, a random access memory (RAM) 13, and a storage device 14. The CPU 11 is a processor for executing various programs. The ROM 12 stores such various programs to be executed. The RAM 13 stores the programs and various types of data. The storage device 14 stores various programs.

The CPU 11, the ROM 12, the RAM 13 and the storage device 14 are connected to each other via a bus 15. The CPU 11, the ROM 12 and the RAM 13 constitute a control unit 100. That is, the CPU 11 or the control unit 100 executes a control process of the cloud server 1, which will be described later, in accordance with a control program stored in the ROM 12 or the storage device 14 and loaded onto the RAM 13.

The storage device 14 is constituted by a non-volatile memory such as a hard disc drive (HDD) or a flash memory that retains stored data even when the power is turned off. The storage device 14 stores a control program 141 for controlling the cloud server 1, an item master 142, customer information 143, and item sales information 144.

The control unit 100 is connected to an operating unit 17 and a display unit 18 via the bus 15 and a controller 16. In response to an instruction from the control unit 100, the controller 16 controls the operating unit 17 and the display unit 18. However, for convenience of explanation, the control performed by the controller 16 will be described as being performed by the control unit 100.

The operating unit 17 is, for example, a keyboard or a touch panel, and is operated by an operator of the cloud server 1. The display unit 18 is, for example, a liquid crystal display (LCD), and displays various kinds of information to the operator of the cloud server 1. The control unit 100 is connected to a communication unit 19 via the bus 15. The communication unit 19 is a network interface circuit that is connected to each edge server 2 via the communication line 4, and transmits and receives various kinds of information. Note that the hardware configuration of the cloud server 1 is not limited to this.

Next, a hardware configuration of the edge server 2 will be described with reference to FIG. 3. FIG. 3 is a block diagram illustrating an example of a hardware configuration of the edge server 2. As illustrated in FIG. 3, the edge server 2 includes a CPU 21, a ROM 22, a RAM 23, a storage device 24, and the like. The CPU 21 is a processor for executing various programs. The ROM 22 stores such programs. The RAM 23 stores the programs to be executed and various types of data. The storage device 24 also stores the programs.

The CPU 21, the ROM 22, the RAM 23, and the storage device 24 are connected to each other via a bus 25. The CPU 21, the ROM 22, the RAM 23 constitute a control unit 200. That is, the CPU 21 or the control unit 200 executes a control process of the edge server 2, which will be described later, in accordance with a control program stored in the ROM 22 or the storage device 24 and loaded onto the RAM 23.

The storage device 24 includes a non-volatile memory such as an HDD or a flash memory that retains stored data even when the power is turned off. The storage device 24 stores a control program 241 for controlling the edge server 2, an item master 242, customer information 243, item sales information 244, priority information 245, usage information 246, and priority order information 247. The item master 242, the customer information 243, and the item sales information 244 stored in the storage device 24 correspond to the item master 142, the customer information 143, and the item sales information 144 stored in the storage device 14 of the store where the edge server 2 is placed. The priority information 245, the usage information 246, and the priority order information 247 will be described later.

The control unit 200 connects the operating unit 27 and the display unit 28 via the bus 25 and the controller 26. In response to an instruction from the control unit 200, the controller 26 controls the operating unit 27 and the display unit 28. However, for convenience of explanation, the control performed by the controller 26 will be described as being performed by the control unit 200.

The operating unit 27 is, for example, a keyboard or a touch panel, and is operated by an operator of the edge server 2. The display unit 28 is, for example, an LCD, and displays various kinds of information to the operator of the edge server 2. The control unit 200 is connected to the communication unit 30 via the bus 25. The communication unit 30 is a network interface circuit that is connected to the cloud server 1 via the communication line 4, and transmits and receives information to and from the cloud server 1. The communication unit 30 is connected to the edge device 3 via the communication line 5, and transmits and receives information to and from the edge device 3. Note that the hardware configuration of the edge server 2 is not limited to this.

Next, a hardware configuration of the POS terminal, which is one of the edge devices 3, will be described with reference to FIG. 4. FIG. 4 is a diagram illustrating an exemplary hardware configuration of the POS terminal according to an embodiment. Note that the POS terminal illustrated in FIG. 4 will be described with reference to the first POS terminal 311. The hardware configuration of the first POS terminal 311 illustrated in FIG. 4 is the same hardware configuration for the second POS terminal 312 and the third POS terminal 313 illustrated in FIG. 1.

As illustrated in FIG. 4, the first POS terminal 311 includes a CPU 31, a ROM 32, a RAM 33, a storage device 34, and the like. The CPU 31 is a processor for executing various programs. The ROM 32 stores such programs. The RAM 33 stores the programs and various types of data. The storage device 34 also stores the programs. The CPU 31, the ROM 32, the RAM 33 and the storage device 34 are connected to each other via a bus 35. The CPU 31, the ROM 32 and the RAM 33 constitute a control unit 300. That is, the CPU 31 or the control unit 300 executes a control process of the first POS terminal 311, which will be described later, in accordance with a control program stored in the ROM 32 or the storage device 34 and loaded onto the RAM 33.

The RAM 33 stores item sales information 331. The storage device 34 is a non-volatile memory such as an HDD or a flash memory that retains stored data even when the power is turned off. The storage device 34 stores a control program 341 for storing a control program for controlling the first POS terminal 311 and an item master 342. The item master 342 is same as the item master 242.

The control unit 300 is connected to an operating unit 41, a display unit for store clerk 42, a display unit for customer 43, a card reading unit 44, a printer 45, and a code reading unit 46 via the bus 35 and the controller 36. In response to an instruction from the control unit 300, the controller 36 controls the operating unit 41, the display unit for store clerk 42, the display unit for customer 43, the card reading unit 44, the printer 45, and the code reading unit 46. However, for convenience of explanation, the control performed by the controller 36 will be described as being performed by the control unit 300.

The operating unit 41 is, for example, a keyboard or a touch panel, and is operated by an operator of the first POS terminal 311, e.g., a salesclerk. The display unit for store clerk 42 is, for example, an LCD, and displays various types of information to the salesclerk. The display unit for customer 43 is, for example, an LCD, and displays various kinds of information to a customer. The card reading unit 44 reads a customer code from a card (for example, a credit card, electronic money, or the like) used by the customer for payment. The control unit 300 of the first POS terminal 311 executes a payment process related to the customer based on the read customer code.

The printer 45 issues a receipt or a slip on which the item information and the item sales information of the items subjected to the item registration processing are printed. The code reading unit 46 images or optically reads symbols such as a bar code and a two-dimensional code attached to each item. The control unit 300 of the first POS terminal 311 executes an item registering process related to the item on the basis of the read symbols. The control unit 300 is connected to the communication unit 47 via the bus 35. The communication unit 47 is a network interface circuit that is connected to the edge server 2 via the communication line 5, and transmits and receives various kinds of information. Note that the hardware configuration of the first POS terminal 311 is not limited to this.

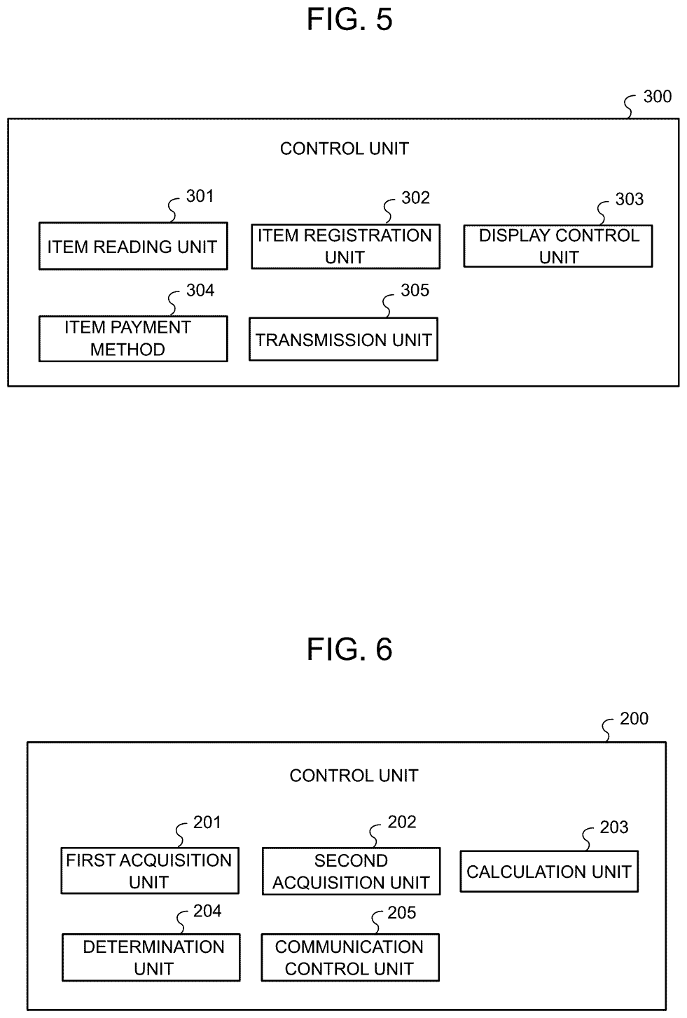

Next, a functional configuration of the POS terminal will be described with reference to FIG. 5. FIG. 5 is a diagram illustrating an exemplary functional configuration of the POS terminal according to an embodiment. Note that the POS terminal illustrated in FIG. 5 will be described with reference to the first POS terminal 311. The functional configuration of the first POS terminal 311 illustrated in FIG. 5 is the same as that of the second POS terminal 312 and the third POS terminal 313 illustrated in FIG. 1.

As illustrated in FIG. 5, the control unit 300 of the first POS terminal 311 performs the functions of an item reading unit 301, an item registration unit 302, a display control unit 303, an item payment unit 304, and a transmission unit 305. Note that the functional configuration of the control unit 300 of the first POS terminal 311 is not limited to this.

The item reading unit 301 reads and decodes a symbol attached to an item. Specifically, the item reading unit 301 controls the code reading unit 46 to image or optically read a symbol such as a bar code and a two-dimensional code attached to an item.

The item registration unit 302 registers the read item. Specifically, the item registration unit 302 registers item information related to the item based on the symbol read and decoded by the item reading unit 301.

The display control unit 303 performs display control so as to output item information related to the registered item. Specifically, the display control unit 303 performs display control so as to output the item information related to the item registered by the item registration unit 302 to the display unit for store clerk 42 and the display unit for customer 43.

The item payment unit 304 settles the item registered. Specifically, the item payment unit 304 calculates the total amount of the item registered based on the item information registered by the item registration unit 302, and settles the total amount by the payment amount paid by the customer. For example, the item payment unit 304 controls the card reading unit 44 to receive an input related to item sales based on the customer code read by the card reading unit 44, calculates the total amount of item registration based on the item information registered by the item registration unit 302, and settles the total amount by the payment amount paid by the customer. Then, the item payment unit 304 outputs the item sales information related to the settled item to the RAM 33.

The transmission unit 305 controls the communication unit 47 to transmit the item sales information. Specifically, the transmission unit 305 controls the communication unit 47 to transmit the item sales information 331 output by the item payment unit 304 and stored in the RAM 33 to the edge server 2.

As described above, the edge server 2 manages the edge devices 3 via the communication line 5. Therefore, if network traffic increases between the edge server 2 and the edge devices 3, there is a possibility that a communication delay occurs. For example, when a large number of customers visit the store, movement of the customers in the store increases, and data communication between the edge server 2 and the network camera 314 increases. As a consequence, the communication process between the edge server 2 and the edge devices 3 may be delayed, and the process for receiving the item sales information from the POS terminal may be delayed.

Since the item sales information relates to the inventory information of the item in the store, if the item sales information transmitted by the POS terminal is delayed, it becomes difficult to manage the inventory quantity of the item in the store, and there is a possibility that the item sales information affects the business of the main commerce in the store. Therefore, the edge server 2 according to the present embodiment connects to the edge devices 3 based on the priority order corresponding to the usage of the edge devices 3.

FIG. 6 is a block diagram illustrating an example of a functional configuration of the edge server 2 according to the present embodiment. As illustrated in FIG. 6, the control unit 200 of the edge server 2 performs the functions of a first acquisition unit 201, a second acquisition unit 202, a calculation unit 203, a determination unit 204, and a communication control unit 205. The functional configuration of the control unit 200 of the edge server 2 is not limited to this.

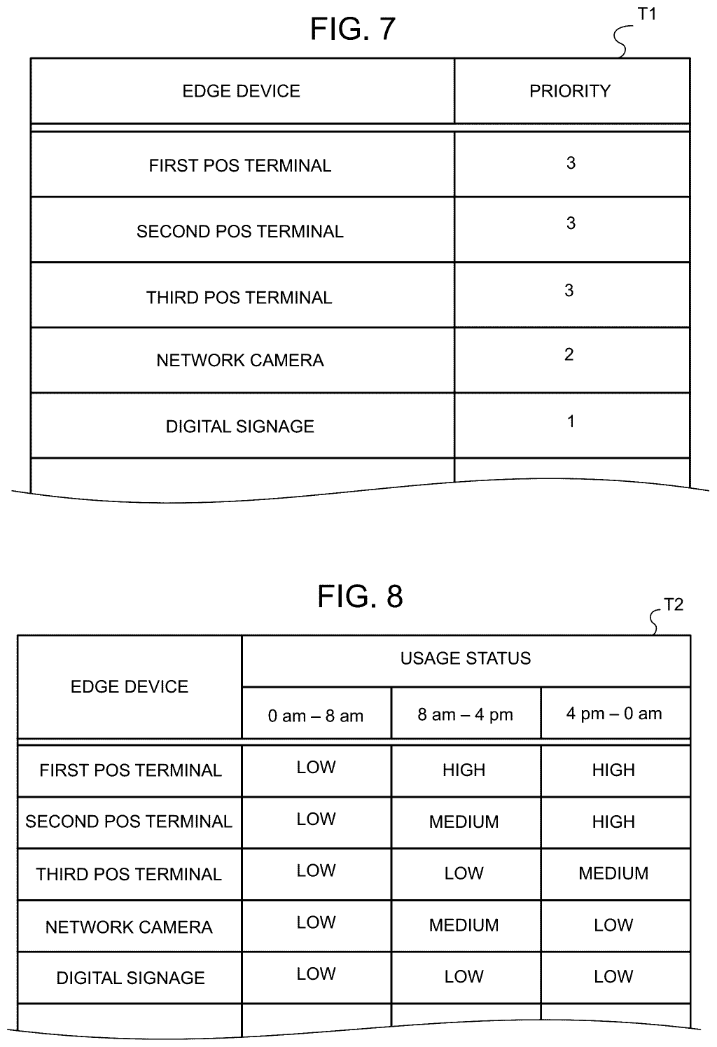

The first acquisition unit 201 acquires the priority information 245 indicating the priority to connect to the edge devices 3. Specifically, the first acquisition unit 201 acquires the priority information 245 stored in the storage device 24. Here, the priority information 245 will be described with reference to FIG. 7. FIG. 7 depicts a data table T1 for storing the priority information 245 according to an embodiment.

As illustrated in FIG. 7, priorities corresponding to the respective edge devices 3 are stored in the table T1. The priorities shown in the table T1 are, for example, 3, 2, and 1, and the higher the numbers, the higher the priorities. The priority is preferably set in accordance with a function and a role each of the edge devices 3 plays in the store operation. That is, among the edge devices 3, the priority of an edge device 3 that generates information related to a commercial transaction at the store is set to be the highest. For example, the edge device 3 needs to receive item sales information transmitted from the POS terminal without delay in order to monitor the inventory quantity of the item in the store. In this instance, the edge device 3 that generates the item sales information 331, that is, the POS terminal is set to be the highest among the edge devices 3. The priority is set in advance by the user.

Returning to FIG. 6, the second acquisition unit 202 acquires usage information 246 indicating the usage states of the plurality of edge devices 3. Specifically, the second acquisition unit 202 acquires the usage information 246 stored in the storage device 24. Here, the usage information 246 will be described with reference to FIG. 8. FIG. 8 illustrates a data table T2 for storing the usage information 246 according to an embodiment.

The table T2 shown in FIG. 8 shows the usage status or frequency of use of the respective edge devices 3. The usage status indicates a status of the device 3 in each of predetermined time periods of a day in the operating hours of the store. In addition, the usage status may be, for example, a usage status on the previous day, a usage status on a weekday or a holiday/holiday, a usage status in a week, or a usage status in a month. The time periods include, for example, three time periods from 12 am to 8 am, from 8 am to 4 pm, and from 4 pm to 12 am. Note that the time periods are not limited to this, and two or four or more time periods may be used.

Note that the usage status is not limited to the usage status of the predetermined time period in the operating hours of the store, and may be the number of processes of data processed by the edge device 3 or the capacity of data processed by the edge device 3. That is, the usage status may be any information indicating an index related to the communication amount and the communication frequency in the communication between the edge server 2 and the edge device 3.

Returning to FIG. 6, the calculation unit 203 calculates a priority number indicating the index of the priorities of the edge devices 3 based on the priority information 245 and the usage information 246. Specifically, the calculation unit 203 calculates the priority number based on the priority information 245 acquired by the first acquisition unit 201 and the priority information 245 acquired by the second acquisition unit 202. The priority number will be described later.

The determination unit 204 determines the priority order for communication for each device 3 based on one or both of the priority set for each device 3 and the usage status for each device 3 in the operating hours of the store. Specifically, the determination unit 204 determines the priority order information 247 indicating the priority order to connect to the edge devices 3 in accordance with the priorities of the edge devices 3 calculated by the calculation unit 203 based on the priority information 245 and the usage information 246. For example, the determination unit 204 determines the priority order for connecting to the edge devices 3 for each time zone.

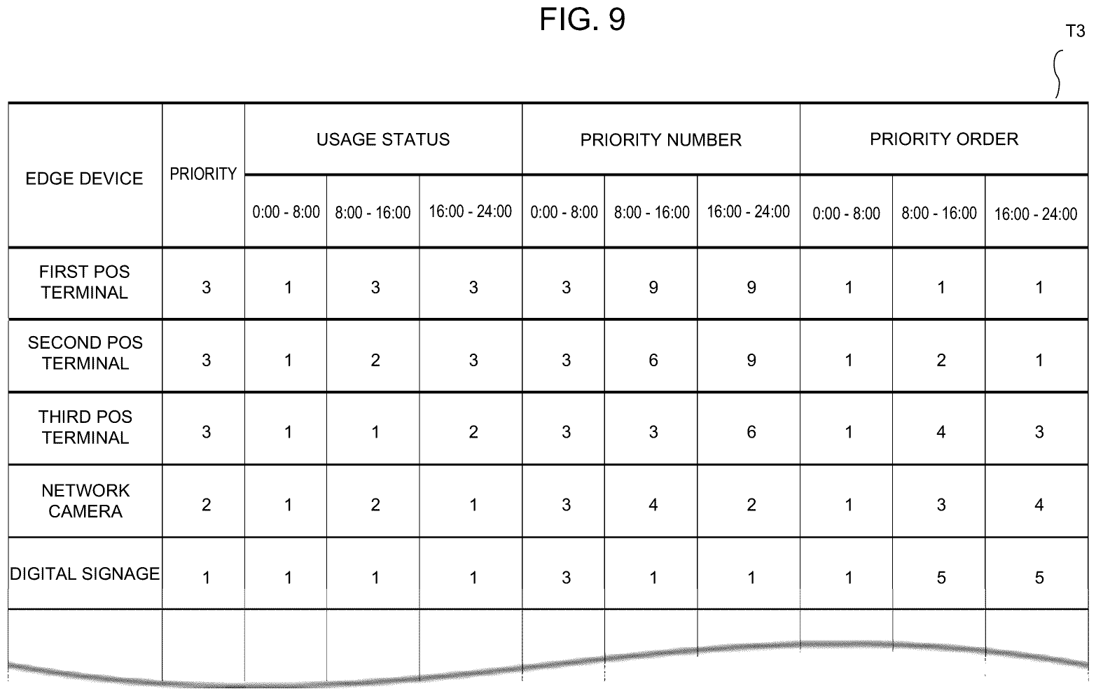

Here, the priority order information 247 will be described with reference to FIG. 9. FIG. 9 is a data table T3 for storing the priority order information 247 according to an embodiment. In the table T3 shown in FIG. 9, priorities corresponding to the edge devices 3, usage states of the edge devices 3, the priority numbers corresponding to the edge devices 3, and the priority order of the edge devices 3 are shown. That is, the priority order information 247 includes a priority to connect to each edge device 3, a usage state of each edge device 3, a priority number corresponding to each edge device 3, and a priority order for each edge device 3.

The usage status illustrated in FIG. 9 corresponds to the usage status illustrated in FIG. 8, and is replaced with a numerical value in order for the calculation unit 203 to calculate the priority number. For example, the usage status illustrated in FIG. 9 is replaced with “1”, “2”, and “3” as numerical values for “low”, “medium”, and “high” in the usage status illustrated in FIG. 8, respectively. For example, the calculation unit 203 multiplies the numerical value of the priority shown in FIG. 9 by the numerical value of the usage status to calculate the priority number for each of the edge devices 3.

Then, the determination unit 204 determines the priority order information 247 illustrated in FIG. 9 in accordance with the priority numbers calculated by the calculation unit 203. Specifically, the determination unit 204 determines the priority order information 247 indicating the priority order for prioritizing the edge device 3 indicating the value having the high priority number. For example, when the time period is from 8:00 to 16:00, the priority order shown in FIG. 9 are “1” for the first POS terminal 311, “2” for the second POS terminal 312, “3” for the network camera 314, “4” for the third POS terminal 313, and “5” for the digital signage terminal 315.

Regarding the priority order, a lower number is given higher priority. Therefore, the order in which the determination unit 204 communicates with the edge server 2 from 8 am to 4 pm is the order of the first POS terminal 311, the second POS terminal 312, the network camera 314, the third POS terminal 313, and the digital signage terminal 315 based on the priority order.

Returning to FIG. 6, the communication control unit 205 connects to the edge devices 3 based on the priority order information 247. Specifically, the communication control unit 205 controls communication with the edge devices 3 based on the priority order in the current time period. For example, the communication control unit 205 connects to the edge devices 3 on the basis of the priority order information 247 determined by the determination unit 204, acquires various kinds of information from the edge devices 3, and transmits various kinds of information to the edge devices 3. The various kinds of information to be acquired are, for example, item sales information 331, imaging data, and the like. The various types of information to be transmitted are, for example, information related to information such as advertisement information and event information.

For example, the communication control unit 205 performs control to change a response time until a response is made in response to a request from the edge device 3 based on the priority order. The communication control unit 205 performs control so that the response time with the edge device 3 having higher priority (i.e., a smaller number) is shorter than the edge device 3 having lower priority (i.e., a higher number). In addition, the communication control unit 205 performs control so that a response time with the edge device 3 having lower priority is longer than that with the edge device 3 having higher priority.

For example, the communication control unit 205 performs control to change the transmission frequency of transmission information including instruction data and the like to be transmitted to the edge device 3. The communication control unit 205 performs control so that the transmission frequency of the edge device 3 having higher priority is higher than that of the edge device 3 having lower priority. Further, the communication control unit 205 performs control so that the transmission frequency of the edge device 3 having lower priority is lower than that of the edge device 3 having higher priority.

For example, the communication control unit 205 performs control for limiting the communication bandwidth between the edge server 2 and the edge device 3. The communication control unit 205 performs control to change the upper limit value of the communication band according to the priority order. The communication control unit 205 performs control so that an upper limit value of a communication band of the edge device 3 having higher priority is larger than that of the edge device 3 having lower priority. Further, the communication control unit 205 performs control so that the upper limit value of the communication band of the edge device 3 having lower priority is smaller than that of the edge device 3 having higher priority.

The lower limit value of the communication band may be changed according to the priority order. For example, the communication control unit 205 performs control to change the upper limit value or the lower limit value of the communication band according to the priority order. The communication control unit 205 performs control so that a lower limit value of a communication band of the edge device 3 having higher priority is smaller than that of the edge device 3 having lower priority. Further, the communication control unit 205 performs control so that the lower limit value of the communication band of the edge device 3 having lower priority is larger than that of the edge device 3 having higher priority.

When the communication connection between the edge server 2 and the edge device 3 is disconnected and thereafter the communication connection is started, the communication control unit 205 may connect to the edge device 3 having the highest priority. In addition, in a case where the communication connection between the edge server 2 and the edge device 3 is disconnected and thereafter the communication connection is started, the communication control unit 205 may reconnect to the edge device 3 in which the communication is disconnected and the various kinds of information are not acquired or the various kinds of information are not transmitted. Thereafter, the communication control unit 205 connects to the edge devices 3 based on the next priority order of the reconnected edge devices 3.

When the priority order included in the priority order information 247 is the same, the communication control unit 205 may be connected based on the priority information 245 of the edge devices 3. That is, when the priority order is the same, the communication control unit 205 may preferentially connect those with higher priorities. When the priority order is identical, the communication control unit 205 may preferentially connect those having the highest priority in the immediately preceding time period.

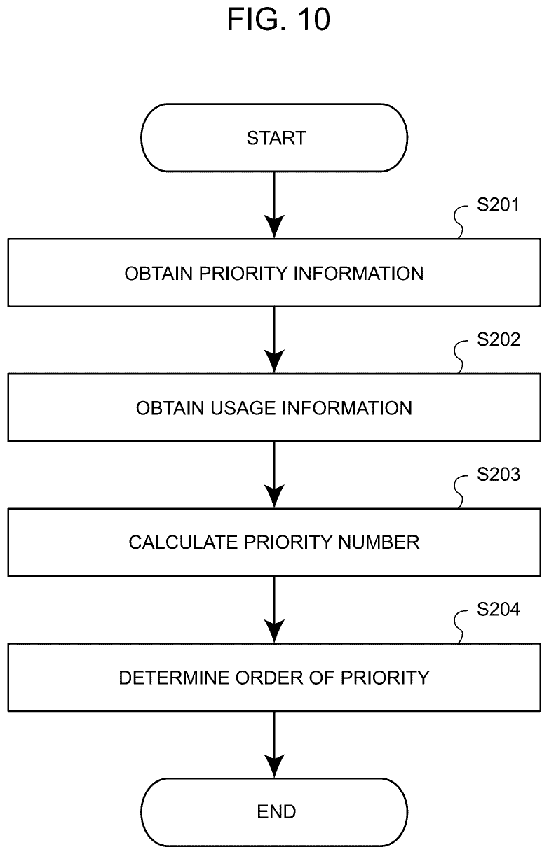

Next, the control process of the edge server 2 will be described with reference to FIG. 10. FIG. 10 is a flowchart illustrating an example of a control process of the edge server 2 according to an embodiment. The flowchart illustrated in FIG. 10 illustrates a process of determining the priority order for the edge server 2 to connect to each of the edge devices 3.

The first acquisition unit 201 obtains the priority information 245 stored in the storage device 24 (step S201). Subsequently, the second acquisition unit 202 obtains the usage information 246 stored in the storage device 24 (step S202). Subsequently, the calculation unit 203 calculates the priority number indicating the index of the priorities connected to the edge devices 3 on the basis of the priority information 245 and the usage information 246 (step S203).

Subsequently, the determination unit 204 determines the priority order information 247 indicating the priority order to connect to the edge devices 3 according to the priority numbers calculated by the calculation unit 203 (step S204). When the process of the step S204 ends, the communication control unit 205 connects to the edge devices 3 based on the priority order information 247 including the priority order.

As described above, the edge server 2 of the present embodiment determines the priority order for each edge device 3 on the basis of one or both of the priority set for the device 3 and the usage status for the device in the operating hours of the store, and controls communication with the edge devices 3 on the basis of the priority order.

Thus, for example, even when transmission and reception between the edge server 2 and the edge devices 3 are increased, the edge server 2 can reduce the occurrence of a communication delay between the edge server 2 and the edge devices 3 by connecting to the edge devices 3 based on the priority order information 247.

Further, the edge device 3 can receive the item sales information transmitted from the POS terminal without delay, for example, by reducing the communication delay of the edge server 2. Further, the edge server 2 can manage the inventory information of the item in the store without delay by receiving the item sales information without delay.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

### First Modification

In the above-described embodiments, the determination unit 204 of the control unit 200 of the edge server 2 determines the priority order information 247 indicating the priority order to connect to the edge devices 3 on the basis of the priority information 245 and the usage information 246, but embodiments of the present invention are not limited thereto. For example, the determination unit 204 may determine the priority order information 247 indicating the priority order to connect to the edge devices 3 based on the priority information 245. Further, the determination unit 204 may determine the priority order information 247 indicating the priority order to connect to the edge devices 3 based on the usage information 246.

The program executed by the edge server 2 of the embodiment is provided by being recorded in a computer-readable recording medium such as a CD-ROM, a flexible disk (FD), or a CD-R, a digital versatile disk (DVD) in an installable format or an executable format.

Further, the program executed by the edge server 2 of the embodiments may be stored in a computer connected to a network such as the Internet, and may be downloaded via the network. Further, the program executed by the edge server 2 of the embodiment may be provided or distributed via a network such as the Internet.

What is claimed is:

1. A store server for managing a plurality of devices in a store via a store network, the store server comprising:
a network interface connectable to the store network;
a memory that stores:
a priority value assigned to each of the devices, and
a plurality of indicators for each of the devices indicating frequency of use in a plurality of time periods of a day; and
a processor configured to:
determine a priority order for the devices based on the priority values assigned to the devices and the indicators for the devices stored in the memory, and
control communication with each of the devices via the network interface according to the determined priority order.

2. The store server according to claim 1, wherein the processor is configured to control a response time to respond to a request from each of the devices according to the determined priority order.

3. The store server according to claim 2, wherein
the devices include a point-of-sale (POS) terminal, and
the processor determines the priority order such that a response time to respond to a request from the POS terminal is the shortest.

4. The store server according to claim 2, wherein
the devices include a POS terminal, a camera, and a digital signage terminal, and
the processor determines the priority order such that a response time to respond to a request from the digital signage terminal is the longest.

5. The store server according to claim 4, wherein the processor determines the priority order such that a response time to respond to a request from the POS terminal is shorter than the camera.

6. The store server according to claim 1, wherein
the network interface is connectable to an external server via another network, and
the processor is configured to:
generate sales information based on data received from one or more of the devices via the store network, and
control the network interface to transmit the sales information to the external server via said another network.

7. The store server according to claim 1, wherein the time periods correspond to business hours of the store.

8. A sales information management system comprising:
a first server; and
a second server for managing a plurality of devices in a store via a store network, the second server including:
a network interface connectable to the devices via the store network and the first server via another network that is different from the store network,
a memory that stores:
a priority value assigned to each of the devices, and
a plurality of indicators for each of the devices indicating frequency of use in a plurality of time periods of a day, and
a processor configured to generate sales information based on data received from one or more of the devices via the store network and control the network interface to transmit the sales information to the first server, wherein
the processor is configured to:
determine a priority order for the devices based on the priority values assigned to the devices and the indicators for the devices stored in the memory, and
control communication with each of the devices via the network interface according to the determined priority order.

9. The sales information management system according to claim 8, wherein the processor is configured to control a response time to respond to a request from each of the devices according to the determined priority order.

10. The sales information management system according to claim 9, wherein
the devices include a point-of-sale (POS) terminal, and
the processor determines the priority order such that a response time to respond to a request from the POS terminal is the shortest.

11. The sales information management system according to claim 9, wherein
the devices include a POS terminal, a camera, and a digital signage terminal, and
the processor determines the priority order such that a response time to respond to a request from the digital signage terminal is the longest.

12. The sales information management system according to claim 11, wherein the processor determines the priority order such that a response time to respond to a request from the POS terminal is shorter than the camera.

13. The sales information management system according to claim 8, wherein the time periods correspond to business hours of the store.

14. A method performed by a store server for managing a plurality of devices in a store via a store network, the method comprising:
storing in a memory:
a priority value assigned to each of the devices, and
a plurality of indicators for each of the devices indicating frequency of use in a plurality of time periods of a day;
determining a priority order for the devices based on the priority values assigned to the devices and the indicators for the devices stored in the memory; and
controlling communication with each of the devices via the store network according to the determined priority order.

15. The method according to claim 14, wherein controlling includes controlling a response time to respond to a request from each of the devices according to the determined priority order.

16. The method according to claim 15, wherein
the devices include a point-of-sale (POS) terminal, and
a response time to respond to a request from the POS terminal is the shortest.

17. The method according to claim 15, wherein
the devices include a POS terminal, a camera, and a digital signage terminal, and
a response time to respond to a request from the digital signage terminal is the longest.

18. The method according to claim 17, wherein a response time to respond to a request from the POS terminal is shorter than the camera.

19. The method according to claim 14, further comprising:
generating sales information based on data received from one or more of the devices via the store network; and
transmitting the sales information to an external server via another network that is different from the store network.

20. The method according to claim 14, wherein the time periods correspond to business hours of the store.
